(19) United States
(12) Patent Application Publication
(10) Pub. No.: US 2010/0272480 A1
(43) Pub. Date: Oct. 28, 2010

(54) IMAGE FORMING APPARATUS AND IMAGE FORMING METHOD

(75) Inventors: Koichi KAMIJO, Matsumoto-shi (JP); Ken IKUMA, Suwa-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/767,439

(22) Filed: Apr. 26, 2010

(30) Foreign Application Priority Data
Apr. 27, 2009 (JP) 2009-107332

(51) Int. Cl. G03G 15/01; G03G 15/16

(52) U.S. Cl. 399/304; 399/314

(57) ABSTRACT

An image forming apparatus including an image carrying belt which has volume resistance from 10⁷ Ωcm to 10¹² Ωcm and carries an image, a roller around which the image carrying belt is wound and which drives the image carrying belt, a transfer roller which includes a transfer material gripper which grips a transfer material which is disposed in a concaved portion of the transfer roller and which comes into pressing contact with the roller with the image carrying belt interposed therebetween so as to transfer the image carried by the image carrying belt to the transfer material, a bias applying unit which applies a transfer bias to the roller, and a ground unit which electrically grounds the transfer roller.

The entire disclosure of Japanese Patent Application No. 2009-107332, filed Apr. 27, 2009 is expressly incorporated herein by reference.

### BACKGROUND OF THE INVENTION

1. Technical Field

The present invention relates to an image forming apparatus and an image forming method of an electrographic type capable of transferring an image of an image carrying member to a transfer material, such as paper, using a transfer roller including a transfer material gripper which comes into pressing contact with an image carrying belt.

2. Related Art

In many wet-type image forming apparatuses which use a liquid developer, since the transfer surface including the toner image comes into pressing contact with an intermediate transfer medium, the transfer material may easily become attached to the intermediate transfer medium, rather than being transferred through the apparatus as desired. In order to solve this problem, there has been suggested an image forming apparatus which separates the transfer material from the transfer roller by blowing air to the front end of the transfer material after the transfer process has been completed. One such apparatus is disclosed in Japanese Patent No. 3128067.

Another proposed solution is an image forming apparatus which uses a dry developer and which transfers a toner image of a photoconductive member to a transfer material in while a gripper of a transfer drum coming into pressing contact with the photoconductive member grips a front end of the transfer material. An example of such an apparatus is found in Japanese Patent Document JP-A-3-4241. By performing the transfer process while the gripper grips the front end of the transfer material, the transfer material subjected to the transferring can easily be separated from the photoconductive member.

Another proposed solution is found in an image forming apparatus which performs transferring using an intermediate transfer belt comprising an elastic belt (for example, see JP-A-2009-36943). By using the elastic belt, the intermediate transfer belt can follow the surface unevenness of a transfer sheet more satisfactorily, thereby obtaining good transfer characteristics.

Unfortunately, none of these proposed solutions have drawbacks. For example, since the image forming apparatus disclosed in Japanese Patent No. 3128067 uses only blown air to separate the front end of the transfer material, it is difficult to separate the transfer material reliably. If the apparatus disclosed in Japanese Patent No. 3128067 is modified so that the separating method of the gripper disclosed in JP-A-3-4241 is used, however, the gripper gripping the transfer material protrudes on the outer circumference of the transfer drum. Therefore, when the gripper reaches a transfer nip, the position of the transfer drum is varied. For this reason, banding occurs, and thus it is difficult to perform the transferring satisfactorily. Moreover, in the image forming apparatus disclosed in JP-A-3-4241, since a transfer bias is applied to the transfer drum, the transfer material is easily adsorbed to the transfer drum due to an electrostatic adsorption force. For this reason, a problem may arise in that it is difficult to separate the transfer material subjected to the transferring from the transfer drum.

### BRIEF SUMMARY OF THE INVENTION

An advantage of some aspects of the invention is that it provides an image forming apparatus and an image forming method capable of reliably separating a transfer material from a transfer roller while performing a satisfactory transferring process.

A first aspect of the invention is an image forming apparatus and an image forming method. A transfer material is gripped by a transfer material gripper disposed in a concaved portion of a transfer roller. With such a configuration, while the transfer material is gripped, an image carried by an image carrying belt is transferred to the transfer material. Accordingly, it is possible to reliably transfer the image from the image carrying belt to the transfer material. Moreover, since the transfer material gripper is disposed in the concaved portion, the satisfactory transferring can be performed.

The transfer roller bringing the image carrying belt into pressing contact with a first roller is electrically grounded. In this way, it is possible to prevent the transfer material from being electrostatically adsorbed to the transfer roller. Accordingly, it is possible to easily separate the transfer material from the transfer roller. By doing so, it is possible to separate the transfer material subjected to the transferring from the image carrying belt reliably, and it is also possible to separate the transfer material from the transfer roller reliably. Moreover, a transfer bias is applied to the first roller capable of winding the image carrying belt with volume resistance of 10⁷ Ωcm to 10¹² Ωcm. With such a configuration, even when the transfer roller is electrically grounded, second transferring can be performed reliably.

### BRIEF DESCRIPTION OF THE DRAWINGS

The invention will be described with reference to the accompanying drawings, wherein like numbers reference like elements.

FIG. 1 is a diagram schematically illustrating a part of an image forming apparatus according to an embodiment of the invention;

FIG. 2 is a partially enlarged view illustrating a second transfer unit of the image forming apparatus shown in FIG. 1;

FIG. 3A is a partial perspective view illustrating the second transfer unit of the image forming apparatus according to the embodiment illustrated in FIG. 1;

FIG. 3B is an enlarged view of part 111B of FIG. 3A;

FIG. 3C is a partial side view illustrating the second transfer unit in FIG. 3A when viewed from the right side;

FIG. 4 is a diagram for explaining separation of a transferred transfer material from the second transfer roller; and

FIG. 5 is a partially enlarged view illustrating the same second transfer unit as that of FIG. 2 in the image forming apparatus according to another embodiment of the invention.

### DESCRIPTION OF EXEMPLARY EMBODIMENTS

Hereinafter, an embodiment of the invention will be described with reference to the drawings.

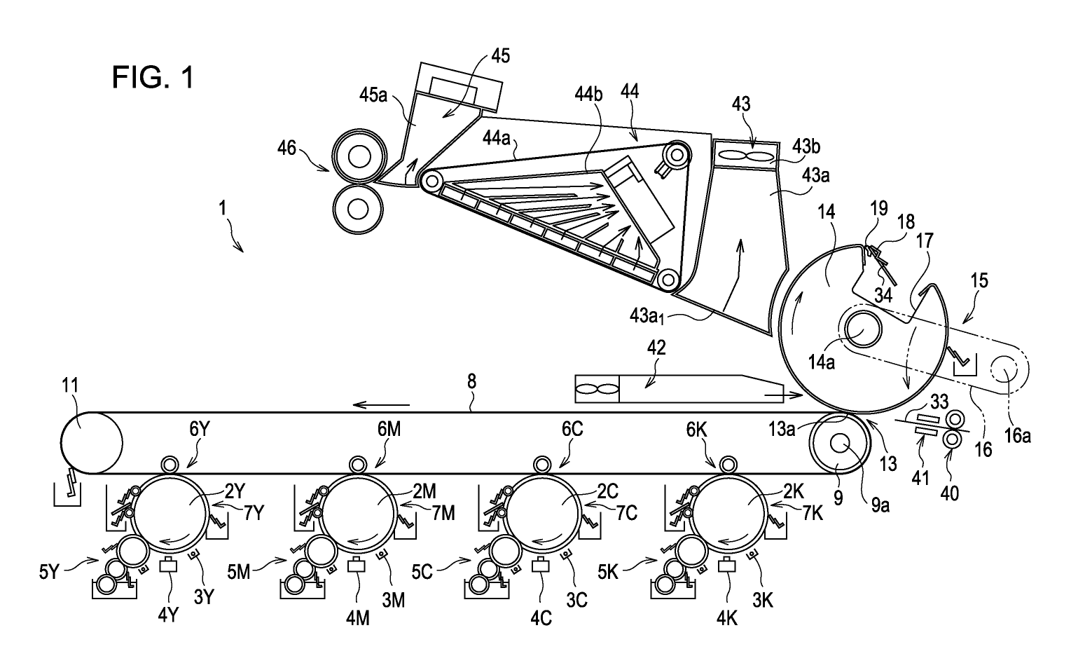

FIG. 1 is a diagram schematically illustrating a part of an image forming apparatus including a transfer device according to one embodiment of the invention.

An image forming apparatus 1 according to the first embodiment forms an image using a liquid developer containing solid content toner and carrier liquid. As shown in FIG. 1, the image forming apparatus 1 includes photoconductive members 2Y, 2M, 2C, and 2K, which are image carrying members of yellow (Y), magenta (M), cyan (C), and black (K) disposed in a tandem in the horizontal or in the substantially horizontal direction. Here, the photoconductive members 2Y, 2M, 2C, and 2K, include the yellow photoconductive member 2Y, the magenta photoconductive member 2M, the cyan photoconductive member 2C, and the black photoconductive member 2K. Likewise, in other members, respective color members are denoted by adding respective colors Y, M, C, and K to reference numerals.

Charging units 3Y, 3M, 3C, and 3K are disposed in the vicinity of the photoconductive members 2Y, 2M, 2C, and 2K, respectively. Exposure units 4Y, 4M, 4C, and 4K, development units 5Y, 5M, 5C, and 5K, first transfer units 6Y, 6M, 6C, and 6K, and photoconductive member cleaning units 7Y, 7M, 7C, and 7K are disposed sequentially from the charging units 3Y, 3M, 3C, and 3K in a rotation direction of the photoconductive members 2Y, 2M, 2C, and 2K, respectively.

The image forming apparatus 1 includes an endless intermediate transfer belt 8 comprising an image carrying belt which serves as a transfer belt. The intermediate transfer belt 8 is disposed above the photoconductive members 2Y, 2M, 2C, and 2K. The intermediate transfer belt 8 comes into pressing contact with the first transfer units 6Y, 6M, 6C, and 6K and the photoconductive members 2Y, 2M, 2C, and 2K.

Although not illustrated, the intermediate transfer belt 8 is a single layer belt formed of polyimide resin. According to the invention, the intermediate transfer belt 8 has either middle volume resistance or high volume resistance. In this case, the specific volume resistance value of the intermediate transfer belt 8 is set to the range from 10⁷ Ωcm to 10¹² Ωcm. In this embodiment, particularly, the intermediate transfer belt 8 has volume resistance of 10⁹ Ωcm and is formed of a single layer polyimide resin with a thickness of 80 μm. The volume resistance of the intermediate transfer belt 8 is measured by Hiresta UP MCP-HT450 type (made by Dia Instrument Co., Ltd) by applying a voltage of 250 V with UR probe to the intermediate transfer belt 8.

When the volume resistance of the intermediate transfer belt 8 is less than 10⁷ Ωcm, discharge easily occurs during the transfer, and deterioration in an image, such as discharge irregularity, may occur. As for the second transfer unit 13, which is described below, current may flow between an intermediate transfer belt driving roller 9 and a second transfer roller 14 at a portion in which the transfer material 33 does not exist. For this reason, a sufficient electric field may not be applied to toner particles at a portion in which the transfer material exists, and thus secondary transfer characteristics may not be ensured at the second transfer.

Moreover, a problem may arise in that charges may be injected into the toner and thus toner charging may be disturbed. On the other hand, when the volume resistance of the intermediate transfer belt 8 is higher than 10¹² Ωcm, the sufficient electric field may not be applied to the toner particles and thus the secondary transfer characteristics necessary for the second transfer by bias may not be ensured.

The intermediate transfer belt 8 is not limited to a single layer belt. The intermediate transfer belt 8 may be formed as a relatively soft elastic belt with a three-layer structure which has a flexible base layer formed of resin, for example, a rubber elastic layer formed on the surface of the base layer, and a surface layer formed on the surface of the elastic layer. Of course, the invention is not limited thereto and other embodiments may be used without departing from the scope of the invention.

The intermediate transfer belt 8 is wound by the intermediate transfer belt driving roller 9, which comprises a first roller, to which a driving force of a motor (not shown) is applied, along with an intermediate transfer belt tension roller 11. The intermediate transfer belt 8 is configured to be rotated in the direction shown by the arrow in FIG. 1, w tension is applied to the intermediate transfer belt 8.

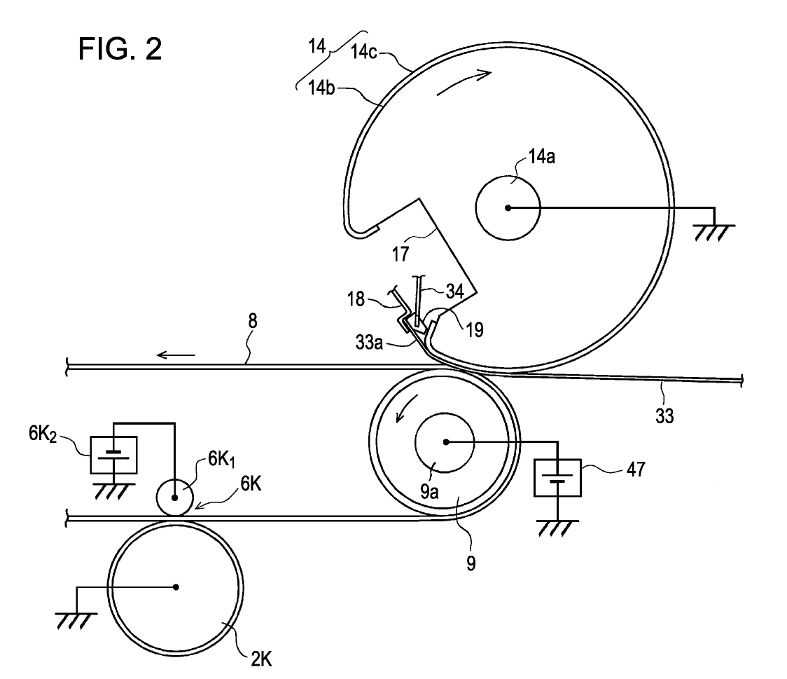

A first transfer bias is applied from a first transfer bias applying unit to first transfer rollers 6Y₁, 6M₁, 6C₁, and 6K₁ of the first transfer units 6Y, 6M, 6C, and 6K (in FIG. 2, the first transfer roller 6K₁ is illustrated as an example of the configuration used for each of the transfer rollers 6Y₁, 6M₁, 6C₁, and 6K₁). In the first transfer units 6Y, 6M, 6C, and 6K, the toner images of the photoconductive members 2Y, 2M, 2C, and 2K are transferred to the intermediate transfer belt 8 upon the application of the first transfer bias. In this case, the toner image later transferred on the intermediate transfer belt 8 is a superimposed on the previously transferred toner image. A full-color toner image is finally transferred on the intermediate transfer belt 8.

The arrangement order of the members such as the photoconductive members corresponding to the colors Y, M, C, and K is not limited to the example illustrated in FIG. 1, and may be set arbitrarily.

A second transfer unit 13 is disposed on the intermediate transfer belt 8 on the side of the intermediate transfer belt driving roller 9. The second transfer unit 13 includes the second transfer roller 14 and a second transfer roller cleaning unit 15. Both end portions of a rotation shaft 14a of the second transfer roller 14 are rotatably supported by a pair of second transfer roller supporting frames 16. The second transfer roller supporting frames 16 are rotatable and pivotable about the rotation shaft 16a, which serves at the pivotal point, and the frames 16 are supported by an apparatus main body (not shown). The second transfer roller supporting frames 16 are urged in an arrow direction by an urging member such as a spring (not shown). The second transfer roller 14 comes into pressing contact with the intermediate transfer belt 8 by the pressure force of the urging member. In this case, the intermediate transfer belt driving roller 9 serves as a backup roller for the pressure of the second transfer roller 14.

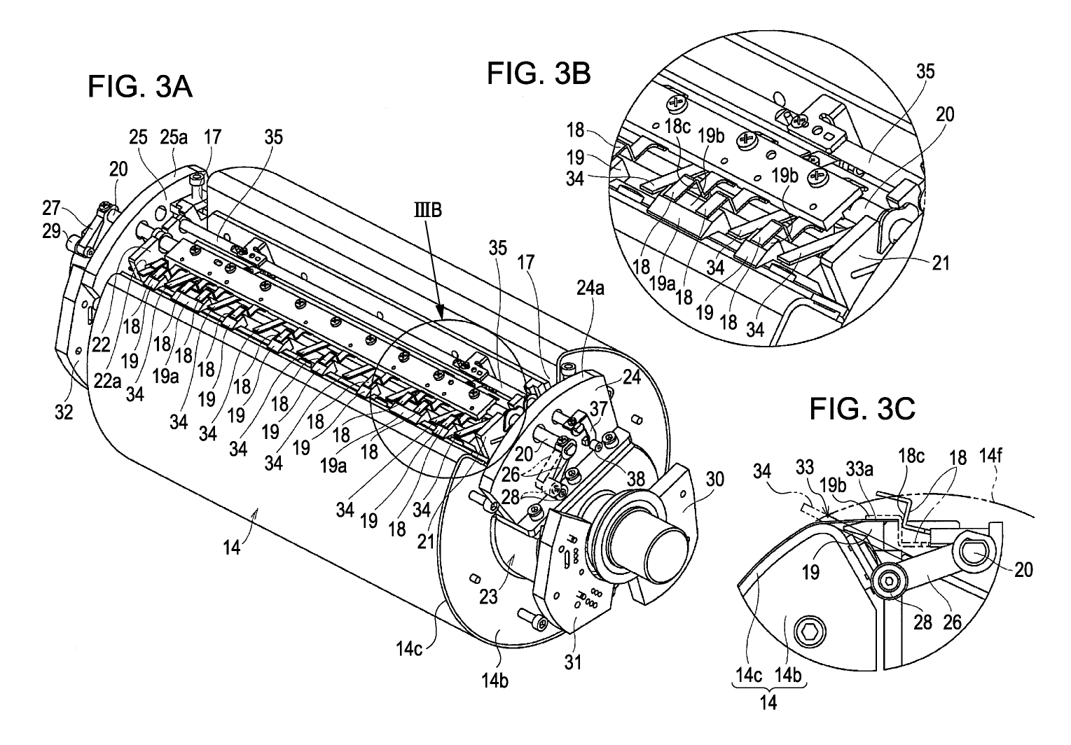

The second transfer roller 14 includes a concaved portion 17. As shown in FIG. 3A, the concaved portion 17 is formed in the axial direction of the second transfer roller 14. The second transfer roller 14 includes an elastic member 14c comprising a sheet wound around the outer circumference of a base layer 14b. The elastic member 14c forms a resistant layer on the outer circumference of the second transfer roller 14. As shown in FIGS. 1, 2, and 4, a second transfer nipping point 13a is formed between the intermediate transfer belt 8 and the elastic member 14c of the second transfer roller 14.

As shown in FIG. 2, the second transfer roller 14 is electrically connected to a grounding unit via a ground wire. For example, the grounding unit grounds the apparatus main body using an AC power source, or using a grounding unit of the facility where the image forming apparatus 1 is installed. A second transfer bias applying unit 47 applies a second high-voltage transfer bias and is disposed in a high-pressure connection portion (a rotation shaft 9a) of the intermediate transfer belt driving roller 9. When the second transfer bias is applied to the intermediate transfer belt driving roller 9, the intermediate transfer belt 8, the intermediate transfer belt driving roller 9, and the second transfer roller 14 are rotated in the direction of the arrows shown in FIG. 2, respectively. Then, in the second transfer nipping point 13a, the toner image of the intermediate transfer belt 8 is transferred to the transfer material 33.

In the concaved portion 17, a gripper 18 serving as a transfer material gripper according to the invention and a gripper supporting portion 19 serving as a transfer material gripper receiver seating the gripper 18 are disposed. As shown in FIGS. 3A and 3B, ten grippers 18 are arranged in the axial direction of the second transfer roller 14. Of course, the number of grippers 18 is not limited to ten, and any number of grippers may be used. Each gripper 18 has a crank shape formed by bending a metal thin strip plate in a shape of two steps.

The grippers 18 are disposed in a rotation shaft 20 so as to rotate together with the rotation shaft 20. Both end portions of the rotation shaft 20 are rotatably supported by supporting plates 21 and 22 erected at the positions facing the concaved portion 17 of the second transfer roller 14.

A first gripper control cam follower 28 is disposed in one end of the rotation shaft 20 with a first arm 26 interposed therebetween. A second gripper control cam follower 29 is disposed in the other end of the rotation shaft 20 with a second arm 27 interposed therebetween. With the rotation of the second transfer roller 14, the first gripper control cam follower 28 is controlled by a first gripper control cam 30 and a third gripper control cam 31. Moreover, with the rotation of the second transfer roller 14, the second gripper control cam follower 29 is controlled by a second gripper control cam (not shown), which is the same as the first gripper control cam 30, and a fourth gripper control cam 32, which is the same as the third gripper control cam 31. The first gripper control follower 28 and the second gripper control cam follower 29 are controlled in a synchronized manner.

As shown in FIGS. 3A and 3B, eight gripper supporting portions 19 are disposed in the axial direction of the second transfer roller 14. The number of gripper supporting portions 19 is not limited to eight, and may be provided so as to correspond to the number of the grippers 18. Among the eight gripper supporting portions 19, the two gripper supporting portions 19a located in both the ends of the second transfer roller 14 are longer than the other gripper supporting portions 19 in the length thereof in the axial direction of the second transfer roller 14. Therefore, the two gripper supporting portions 19 are configured so as to correspond to the size of the transfer material 33 in the axial direction of the second transfer roller 14.

As shown in FIGS. 3B and 3C, gripper contact portions 19b coming into contact with the grippers 18 are disposed in the gripper supporting portions 19 and 19a, respectively. The corresponding grippers 18 are configured so as to come into contact with or separate from the gripper contact portions 19b of the gripper supporting portions 19 and 19a. By controlling of the first gripper control cam follower 28 and the second gripper control cam follower 29 described above, the grippers 18 come into contact with and separate from the gripper supporting portions 19 and 19a. That is, when a front end 33a of the transfer material 33 fed from a gate roller 40 via a transfer material supply guide 41 comes into contact with an end portion 18c, as in FIG. 3C, the grippers 18 grip the front end 33a between the gripper contact portions 19b of the gripper supporting portions 19 and 19a by the control of the first gripper control cam follower 28 and the second gripper control cam follower 29 (gripping of the transfer material). The transfer material 33 is gripped immediately before the concaved portion 17 reaches a portion corresponding to the second transfer nipping point. A transfer material gripper is formed by the grippers 18 and the gripper supporting portions 19 and 19a.

After the grippers 18 grip the transfer material 33, the transfer material 33 gradually comes into contact with the outer circumference of the second transfer roller 14 until a rear end 33b comes into contact with the outer circumference thereof. At this time, the second transfer roller 14 is in a ground state. Therefore, the transfer material 33 is prevented from being electrostatically adsorbed to the second transfer roller 14. After the concaved portion 17 passes through the position corresponding to the second transfer nipping by the controlling the first gripper control cam follower 28 and the second gripper control cam follower 29, the grippers 18 separate from the gripper supporting portions 19 and release the front end 33a of the transfer material 33.

Here, the meaning of the position corresponding to the second transfer nipping point is as follows. That is, when the concaved portion 17 comes to a position facing the intermediate transfer belt driving roller 9, the concaved portion 17 (specifically, a portion in which the concaved portion is formed) of the second transfer roller 14 does not come into contact with the intermediate transfer belt 8. Because no contact is made between the concaved portion 17 and the intermediate transfer belt 8, the second transfer nipping point 13a is not formed between the intermediate transfer belt 8 and the second transfer roller 14. Here, a formation position of the second transfer nipping point 13a at which the second transfer roller 14 comes into pressing contact with the intermediate transfer belt 8 and the width in each rotation direction of the second transfer roller 14 and the intermediate transfer belt 8 becomes the maximum is referred to as a second transfer nipping point correspondence position, which occurs when the concaved portion 17 faces the formation position of the second transfer nipping point 13a.

As indicated by a two-dot chain line of FIG. 3C, all of the grippers 18 are located so as to be evacuated inward from an imaginary outline 14f of the circumference of the elastic member 14c of the second transfer roller 14 in a state where the gripping portions in the front ends of the grippers 18 grip the front end 33a of the transfer material 33 between the gripper supporting portions 19. When the grippers 18 are located at a releasing position indicated by a solid line of FIG. 3C, the gripping portions in the front ends of the grippers 18 are located so as to protrude outward beyond the imaginary outline 14f of the elastic member 14c.

When the front end 33a of the transfer material 33 is gripped by the grippers 18 of the grounded second transfer roller 14, the toner image of the intermediate transfer belt 8 is transferred to the transfer material 33 at the second transfer nipping point 13a by the second transfer bias applied to the intermediate transfer belt driving roller 9, as such the transfer bias is applied and the toner image is transferred. The circumference of the second transfer roller 14 excluding the width of the concaved portion 17 in the rotation direction is set to be larger than the length of the longest transfer material 33 used in the image forming apparatus 1. Therefore, the toner image of the intermediate transfer belt 8 is reliably transferred even to the transfer material 33 of the longest length.

After the portion of the front end 33a of the transfer material 33 gripped by each gripper 18 passes through the second transfer nipping point 13a, each gripper 18 starts moving away from the gripper supporting portion 19 and the front end 33a of the transfer material 33 is released.

Extrusion claws 34 serving as separation members are disposed in the concaved portion 17. As shown in FIGS. 3A and 3B, nine extrusion claws 34 are arranged in the axial direction of the second transfer roller 14. Of course, the number of extrusion claws 34 is not limited to nine, and any number of extrusion claws may be used. The extrusion claws 34 are formed from a metal thin strip plate so as to have the same shape and the same size. The extrusion claws 34 are guided in straight guide holes formed in the supporting plates 21 and 22 to be integrally moved in a straight line. On the other hand, a rotation shaft 35 is supported in the supporting plates 21 and 22 so as to be relatively rotated. The rotation of the rotation shaft 35 is converted into the straight movement of the extrusion claws 34 by a known movement conversion mechanism (not shown).

The extrusion claws 34 are configured to move between an evacuation position indicated by the solid line of FIG. 3C and an extrusion position indicated by the two-dot chain line of FIG. 3C by the straight movement. When the extrusion claws 34 are located at the evacuation position, all of the extrusion claws 34 are located inward from the imaginary line 14f, that is, in the concaved portion 17. When the extrusion claws 34 are located at the extrusion position, the front ends of the extrusion claws 34 protrude outward from the imaginary line 14f, that is, outside the concaved portion 17. Moreover, when the extrusion claws 34 are located at the evacuation position, the extrusion claws 34 do not come in contact with the rear surface of the transfer material 33. When the extrusion claws 34 are located at the extrusion position, the extrusion claws 34 come into contact with the rear surface of the transfer material 33 and protrude from the outer circumference of the second transfer roller 14, the protrusion causes the rear surface of the transfer material 33 to be separated from the outer circumference surface of the second transfer roller 14.

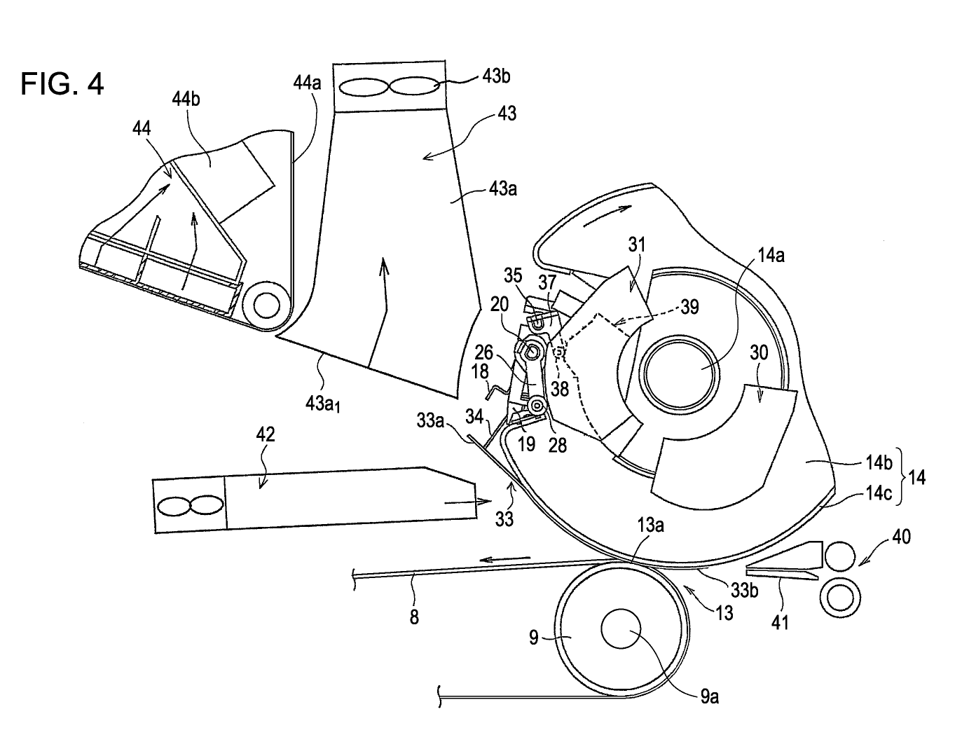

As shown in FIGS. 3A and 4, a first extrusion claw control cam follower 38 is disposed in one end of the rotation shaft 35 formed through the supporting plate 21 with an arm 37 interposed therebetween. A second extrusion claw control cam follower (not shown), which is the same as the first extrusion claw control cam follower 38, is disposed in the other end of the rotation shaft 35 formed through the supporting plate 22 with an arm (not shown), which is the same as the arm 37, interposed therebetween. With the rotation of the second transfer roller 14, the first extrusion claw control cam follower 38 is controlled by a first extrusion claw control cam 39. With the rotation of the second transfer roller 14, the second extrusion claw control cam follower (not shown) is controlled by the second extrusion claw control cam (not shown). The control of the first and second extrusion claw control cam followers is synchronized.

After the concaved portion 17 passes through the second transfer nipping point correspondence position with the rotation of the second transfer roller 14, the extrusion claws 34 start moving toward the extrusion position while the grippers 18 release of the front end 33a of the transfer material 33. As shown in FIG. 4, the extrusion claws 34 are located at the extrusion position and thus the rear surface of the transfer material 33 is separated from the outer circumference of the second transfer roller 14. At this time, since the transfer material 33 is prevented from being electrostatically adsorbed to the second transfer roller 14, as described above, the transfer material 33 is reliably separated from the second transfer roller 14. Moreover, the extrusion claws 34 guide the transfer material 33 separated from the second transfer roller 14 to a second air current generating mechanism 43, which is described in more detail below, and sends the transfer material to a guide surface 43a₁ of the second air current generating mechanism 43. In this way, the extrusion claws 34 form a transfer material receiving and sending member which reliably receives and sends the transfer material 33 separated from the second transfer roller 14 to the second air current generating mechanism 43 of a subsequent processing unit for absorbing and guiding the transfer material.

When the extrusion claws 34 separate from the rear surface of the transfer material 33 with the further rotation of the second transfer roller 14, the extrusion claws 34 are moved to the evacuation position. The extrusion claws 34 are maintained in the evacuation position until the extrusion claws 34 are moved to the extrusion position with the release of the front end 33a of the transfer material 33 by the grippers 18 in the subsequent image forming operation, as described above.

As shown in FIG. 3A, a contact member supporting portion 23 is disposed in one end of the second transfer roller 14 so as to be rotated together with the second transfer roller 14. A first contact member 24 serving as a first positioning member is erected in the contact member supporting portion 23. Likewise, a contact member supporting portion, which is the same as the contact member supporting portion 23, is also disposed in the other end of the second transfer roller 14. A first contact member 25 serving as the first positioning member is also erected in the contact member supporting portion. The first contact members 24 and 25 are rotated together with the second transfer roller 14. The first contact members 24 and 25 respectively have an outer circumference comprising a circular arcs 24a and 25a which are concentric with the circular arc outer circumference of the second transfer roller 14.

On the other hand, although not illustrated, second contact members serving as a second positioning member are respectively disposed in the both ends of the rotation shaft 9a of the intermediate transfer belt driving rollers 9.

When the first contact members 24 and 25 are located at positions so that they do not face the second contact members, the elastic member 14c of the second transfer roller 14 comes into contact with the intermediate transfer belt 8 to form the second transfer nipping point 13a. In this case, the concaved portion 17 of the second transfer roller 14 hardly faces the second transfer nipping point correspondence position.

When the first contact members 24 and 25 are respectively located at the position facing the second contact members, the outer circumferences 24a and 25a of the first contact members 24 and 25 respectively come into contact with the corresponding second contact members. At this time, a part or the whole of the concaved portion 17 of the second transfer roller 14 faces the above-described second transfer nipping point correspondence position. In this way, even when the first contact members 24 and 25 come into contact with the second contact members and the concaved portion 17 facing the second transfer nipping point correspondence position, the second transfer roller 14 is does not vary its position respective to the intermediate transfer belt 8 and the intermediate transfer belt driving roller 9 and is positioned nearly uniformly. Moreover, when the first contact members 24 and 25 come into contact with the second contact members, the first contact members 24 and 25 are electrically insulated from the second contact members. Therefore, electric conduction does not occur between the first contact members 24 and 25 and the second contact members.

The second transfer roller cleaning unit 15 removes a liquid developer attached to the elastic member 14c of the second transfer roller 14 by using a cleaning member such as a cleaning blade. The second transfer roller cleaning unit 15 also collects the removed liquid developer and stores the collected liquid developer in a liquid developer collection container.

As shown in FIG. 1, the image forming apparatus 1 includes a first air current generating mechanism 42, the second air current generating mechanism 43, a transfer material transporting unit 44, and a third air current generating mechanism 45, and a fixing unit 46. The first air current generating mechanism 42 blows air indicated by an arrow toward the front end 33a of the transfer material 33 which has been released from the grip of the grippers 18. With such a configuration, the front end 33a of the transfer material 33 is prevented from following the intermediate transfer belt 8 and being moved.

The second air current generating mechanism 43 includes a suction member 43a and an air current generator 43b such as a fan. When the air current generator 43b generates air current, the suction member 43a sucks air. When the suction member 43a sucks the air, the rear surface (which is a surface opposite to the transfer surface of the toner image) of the transfer material 33 separated and sent from the second transfer roller 14 by the extrusion claws 34. In this way, while the transfer material 33 is sucked and guided by the guide surface 43a₁ of the suction member 43a, the transfer material 33 is moved to the transfer material transporting unit 44 by the rotational force of the intermediate transfer belt 8 and the second transfer roller 14.

The transfer material 33 moved to the transfer material transporting unit 44 is transported to the third air current generating mechanism 45 through an endless transfer material transporting belt 44a rotated in an arrow direction, while being sucked by air suction of a suction member 44b. The transfer material 33 transported to the third air current generating mechanism 45 is moved to the fixing unit 46 by the rotational force of the transfer material transporting belt 44a, while being sucked by the suction member 45a of the third air current generating mechanism 45. Then, the toner image of the transfer material 33 is heated, pressurized, and fixed by the fixing unit 46.

Since other components and other image forming operations of the image forming apparatus 1 according to this embodiment are the same as those of known image forming apparatuses using a liquid developer, their description is omitted.

According to the image forming apparatus 1 and the image forming method of the first embodiment, the front end 33a of the transfer material 33 can be gripped by the grippers 18, and the image, transferred to the intermediate transfer belt 8 and formed of the liquid developer containing the toner and a carrier liquid is transferred to the transfer material 33. Therefore, after the transferring, the transfer material 33 can be reliably separated from the intermediate transfer belt 8. In this way, the transfer material 33 can be both reliably gripped and released. Moreover, since the grippers 18 are disposed in the concaved portion 17, the transferring can be performed satisfactorily.

Since the ground unit of the second transfer roller 14 is electrically connected, the transfer material 33 can be prevented from being electrostatically adsorbed to the second transfer roller 14. Therefore, the transfer material 33 can be separated from the second transfer roller 14 more reliably and more satisfactorily. In this way, the transfer material 33 subjected to the transferring can be separated from the intermediate transfer belt 8 reliably and the transfer material 33 can also be separated from the second transfer roller 14 reliably. Moreover, the second transfer bias is applied to the intermediate transfer belt driving roller 9 winding the intermediate transfer belt 8 with the volume resistance of 10⁷ Ωcm to 10¹² Ωcm. Therefore, even when the second transfer roller 14 is electrically grounded, the second transferring can be performed reliably.

Moreover, since the transfer material 33 subjected to the transferring is separated from the second transfer roller 14 by the extrusion claws 34 serving as the separation member, the separation of the transfer material 33 can be reliably performed by preventing the electrostatic adsorption. Thus, the separation of the transfer material 33 from the second transfer roller 14 can be performed more effectively.

The extrusion claws 34 form a transfer material receiving and sending member and the extrusion claws 34 receive and send the transfer material 33 separated from the second transfer roller 14 from and to the second air current generating mechanism 43. Thus, the extrusion claws 34 perform the transfer material guiding operation to guide the transfer material 33 to the transfer material transporting unit 44. In this way, the transfer material 33 can be received and sent to the second air current generating mechanism 43 so that subsequent processes may be performed and a wider transport space of the transfer material 33 can also be ensured.

By forming the intermediate transfer belt 8 as the elastic belt, the unevenness of the surface of the transfer material 33 can be followed more reliably. On the contrary, when the elastic belt is used, the transfer material 33 can be wound around the intermediate transfer belt 8 easily. Therefore, the transfer material 33 can be separated from the intermediate transfer belt 8 more effectively by the grip of the transfer material 33 by the grippers 18, even when the intermediate transfer belt 8 is formed as the elastic belt.

A specific example of the image forming apparatus 1 according to the invention will be described.

First, the intermediate transfer belt 8 is formed as the relatively soft elastic belt with the three-layer structure, as described above. The base layer is formed of a 100 μm thick polyimide material of which bending endurance is excellent, growth is less due to belt tension, and thermal resistance is excellent. Urethane rubber with a thickness of 200 μm and hardness JIS-A30 degrees is used in the elastic layer. Moreover, a 10 μm thick material in which fluorine resin is added to fluorine containing rubber is used in the surface layer. The entire volume resistance value of the intermediate transfer belt 8 is 10¹⁰ Ωcm.

The base layer 14b of the second transfer roller 14 is formed by forming a base layer made of polyimide resin with a 50 μm film thickness on the outer circumference of a roller made of a conductive metal material such as iron. The elastic member 14c is formed by forming a surface layer made of fluorine containing rubber with a 5 μm thickness on urethane rubber on a sheet with a 5.0 mm film thickness. The entire volume resistance value of the second transfer roller 14 is 6×10¹⁰ Ωcm.

A known material can be used in the intermediate transfer belt roller 9. For example, there is used a material in which a urethane coat with small resistance serving to prevent slipping is formed on the surface of a conductive base made of iron. The volume resistance of the intermediate transfer belt roller 9 is small enough to be ignored in comparison to each volume resistance of the intermediate transfer belt 8 and the second transfer roller 14.

The second transfer bias applied to the intermediate transfer belt roller 9 is set to +1000 V.

The pressure contact force (nip load) of the second transfer roller 14 is set to 90 kgf (900 N). The width (the length in the rotation direction of the second transfer roller 14) of the second transfer nipping point 13a is set to 5 mm. The length (the length in the axial direction of the second transfer roller 14) of the second transfer nipping point 13a is set to 300 mm. Therefore, the nip pressure P of the second transfer nipping point 13a satisfies a relation of P=900/0.5/30=60 [N/cm²].

In this case, it is preferable that the toner is positively-charged toner and the first transfer bias is about −400 V.

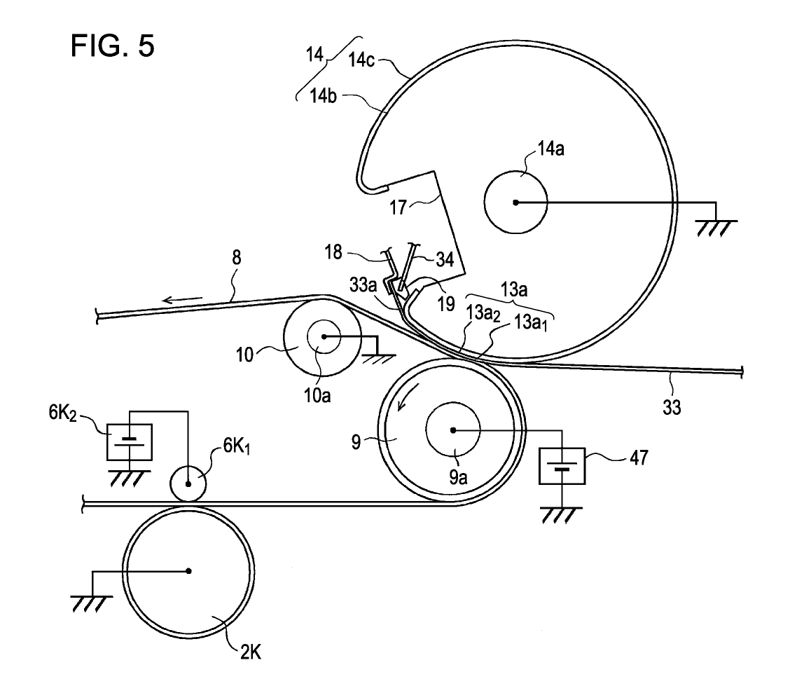

FIG. 5 is a partially enlarged view illustrating the same second transfer unit as that of FIG. 2 in the image forming apparatus according to another embodiment of the invention.

In the image forming apparatus 1 according to this embodiment, as shown in FIG. 5, the intermediate transfer belt 8 is wound by the intermediate transfer belt driving roller 9, a winding roller 10 (corresponding to a second roller), and a driven roller 11 by tension. The intermediate transfer belt 8 is wound into the second transfer roller 14 by the winding roller 10. With such a configuration, the second transfer nipping point 13a is formed as a long nipping point of a pressure contact nipping point 13a₁ pressurized by the second transfer roller 14 and a winding nipping point 13a₂ wound by the winding roller 10. The driven roller 10 is grounded via a rotation shaft 10a. The other configuration of the image forming apparatus 1 according to this embodiment is the same as that described above.

As the second transfer nipping point 13a is formed as the long nipping point, the second transfer can be performed satisfactorily, thereby improving the transfer characteristics. However, when the intermediate transfer belt 8 is wound into the second transfer roller 14, the transfer material 33 can be wound into the intermediate transfer belt 8 easily at the time of the second transfer. In particular, in the image forming apparatus 1 using the liquid developer, it is strongly likely that the transfer material 33 is wound into and attached to the intermediate transfer belt 8. At this time, when the second transfer is performed in the state where the transfer material 33 is gripped by the grippers 18, the transfer material 33 subjected to the transferring can effectively be separated from the intermediate transfer belt 8. The other advantages of the image forming apparatus 1 according to this embodiment are the same as those described above.

The invention is not limited to the image forming apparatus and the image forming method described herein using the illustrative embodiments and various other embodiments may be used without departing from the meaning or scope of the claims. For example, the photoconductive member which is formed in the endless belt and the belt-shaped photoconductive member may be used instead of the intermediate transfer belt 8 serving as the image carrying belt. In this case, of course, the toner image on the photoconductive member is directly transferred to the transfer material. The image forming apparatus described in the two embodiments detailed above are tandem type image forming apparatuses, but other types of image forming apparatus may be used or a monochrome type image forming apparatus may be used. Thus, the invention may be modified in various forms without departing from the scope of the claims of the invention.

What is claimed is:

1. An image forming apparatus comprising:
an image carrying belt that stores an image and that has volume resistance in the range from 10⁷ Ωcm to 10¹² Ωcm;
a roller around which the image carrying belt is wound;
a transfer roller that includes a transfer material gripper that grips a transfer material, the transfer roller also including a concaved portion in which the transfer material gripper is disposed and that comes into pressing contact with the roller with the image carrying belt interposed therebetween so as to transfer the image stored on the image carrying belt to the transfer material;
a bias applying unit that applies a transfer bias to the roller; and
a ground unit that electrically grounds the transfer roller.

2. The image forming apparatus according to claim 1, further comprising a separation member that separates the transfer material from the transfer roller and which is disposed in the concaved portion.

3. The image forming apparatus according to claim 1, wherein the image carrying belt has an elastic layer.

4. The image forming apparatus according to claim 1, further comprising a second roller that winds the image carrying belt and winds the image carrying belt tensioned by the roller into the transfer roller.

5. An image forming method comprising:
gripping a transfer material using a transfer material gripper disposed in a concaved portion of a transfer roller;
applying a transfer bias to a roller around which an image carrying belt carrying an image is wound; and
transferring the image carried by the image carrying belt to the transfer material using the transfer bias, while bringing the image carrying belt into pressing contact with the electrically grounded transfer roller.

6. An image forming apparatus comprising:
an image carrying belt including a base layer formed from a polyimide material, an elastic layer formed on the base layer which is formed from an elastic material, and a surface layer that stores an image, wherein the combined volume resistance of the image carrying belt is in the range from 10⁷ Ωcm to 10¹² Ωcm;
a roller around which the image carrying belt is wound;
a transfer roller that includes a transfer material gripper that grips a transfer material, the transfer roller also including a concaved portion in which the transfer material gripper is disposed and that comes into pressing contact with the roller with the image carrying belt interposed therebetween so as to transfer the image stored on the image carrying belt to the transfer material;
a bias applying unit that applies a transfer bias to the roller; and
a ground unit that electrically grounds the transfer roller.

7. The image forming apparatus according to claim 6, further comprising a separation member that separates the transfer material from the transfer roller and which is disposed in the concaved portion.

8. The image forming apparatus according to claim 6, further comprising a second roller that winds the image carrying belt and winds the image carrying belt tensioned by the roller into the transfer roller.
